(19) United States
(12) Patent Application Publication
(10) Pub. No.: US 2026/0042947 A1
(43) Pub. Date: Feb. 12, 2026

(54) HIGHLY WEAR-RESISTANT WET PAPER-BASED FRICTION MATERIAL, PREPARATION METHOD AND USE THEREOF

(71) Applicants: SINOLIGHT FIBER COMPOSITE MATERIAL TECHNOLOGY (LANGFANG) CO., LTD., Langfang City (CN); CHINA NATIONAL PULP & PAPER RESEARCH INST. CO.,LTD, Beijing (CN)

(72) Inventors: Hong LI, Beijing (CN); Sha LI, Beijing (CN); Weiting HU, Beijing (CN); Xuemei WEN, Beijing (CN); Chunsheng JIANG, Beijing (CN); Yujia XIAN, Beijing (CN); Jinchang WANG, Beijing (CN); Yanfen DU, Beijing (CN); Jingeng ZHUANG, Beijing (CN)

(21) Appl. No.: 18/973,669

(22) Filed: Dec. 9, 2024

(30) Foreign Application Priority Data
Aug. 6, 2024 (CN) 202411069620.0

(51) Int. Cl. C09K 3/14; D21H 25/00; D21H 25/04; D21H 27/00

(52) U.S. Cl. CPC C09K 3/149; D21H 25/005; D21H 25/04; D21H 27/00

(57) ABSTRACT

Provided are a highly wear-resistant highly wear-resistant wet paper-based friction material, a preparation method and use thereof. A natural fiber, a synthetic fiber, a friction performance modifier, and water are mixed to obtain a slurry, the slurry is subjected to dehydration forming and drying in sequence to obtain a base paper, the base paper is impregnated in a phenolic resin impregnation solution including a nanocellulose and then dried to obtain an impregnated paper, and the impregnated paper is subjected to hot-pressing vulcanization at a temperature of not greater than 230° C. to obtain the highly wear-resistant wet paper-based friction. The nanocellulose is added into the impregnation solution, such that the nanocellulose reacts chemically with the phenolic resin to generate a network composite macromolecule during the hot-pressing vulcanization.

### CROSS REFERENCE TO RELATED APPLICATION

This patent application claims the benefit and priority of Chinese Patent Application No. 202411069620.0 filed with the China National Intellectual Property Administration on Aug. 6, 2024, the disclosure of which is incorporated by reference herein in its entirety as part of the present application.

### TECHNICAL FIELD

The present disclosure relates to the technical field of friction materials, and in particular to a highly wear-resistant wet paper-based friction material, a preparation method and use thereof.

### BACKGROUND

Highly wear-resistant wet paper-based friction material are fiber composite materials that work in an oil medium. The friction materials are prepared by using a cellulose fiber or a synthetic fiber as a reinforcing fiber, adding with a friction performance modifier and a filler, and then subjecting a resulting system to papermaking forming, impregnation with a binder resin, and hot-pressing curing in sequence. The highly wear-resistant wet paper-based friction material have the advantages of high dynamic friction coefficient, static/dynamic friction coefficient ratio of approximately 1, strong torque transmission capacity, low friction noise, gentle and smooth bonding process, desirable wear resistance, and designable structure shape, and thus are widely used in transmission and braking devices of various vehicles and engineering machinery, including wet clutches in vehicle automatic transmissions, motorcycle clutches, and wet brakes on heavy vehicles.

Highly wear-resistant wet paper-based friction material must have a suitable and stable friction coefficient and a desirable wear resistance. Wear resistance is a key factor directly related to the safety and service life of a product, as well as an important technical indicator for measuring durability of friction materials. Better wear resistance means a longer service life. Chinese patent CN107326721A has disclosed a method for preparing a paper-based friction material with uniform pores. Specifically, alumina, potassium feldspar and other raw materials are mixed and ball-milled to obtain a ball-milled powder, and the ball-milled powder is filled into a mold and then subjected to high-temperature melt drawing to obtain a mixed chopped fiber. Then an aluminum isopropoxide powder is mixed and dispersed in a glacial acetic acid solution, and a silica sol is added into a resulting mixture, and then mixed with tetraethylammonium hydroxide and other components to obtain a modified mixed solution. Then, the mixed chopped fiber is added into the modified mixed solution, and a resulting mixture is dispersed and dried, and then mixed with bamboo fiber and water. A resulting mixture is subjected to defibering, and a resulting system is then placed on a paper-forming device with a screen, and subjected to drying and immersion in a phenolic resin ethanol solution in sequence to obtain an immersed product. The immersed product is taken out and vulcanized to obtain a paper-based friction material with uniform pores. In the method, the high-temperature melt drawing is preheated at a temperature of 250° C. to 300° C. in a nitrogen protective atmosphere for 25 min to 30 min, and then heated to a temperature of 1,750° C. to 1,800° C. at a heating rate of 15° C./min, and then subjected to insulating and melting for 1 h to 2 h. After the insulation and melting are completed, a glass rod is used to draw resulting wires at a crucible outlet. The paper-based friction material prepared by this patent shows the characteristics of a high friction coefficient and desirable controllability of void structure, which is an ideal friction material. However, the method according to the patent has complicated steps, and the high-temperature melt drawing requires a special high-temperature resistant device, which shows both high energy consumption and production cost.

### SUMMARY

In view of this, an object of the present disclosure is to provide a highly wear-resistant wet paper-based friction material, a preparation method and use thereof. In the present disclosure, the preparation method has the advantages of simple steps, no need of a special high-temperature resistant device, and low energy consumption and production cost.

To achieve the object, the present disclosure provides the following technical solutions:

The present disclosure provides a method for preparing a highly wear-resistant wet paper-based friction material, including the following steps:
mixing a natural fiber, a synthetic fiber, a friction performance modifier, and water to obtain a slurry;
subjecting the slurry to dehydration forming and drying in sequence to obtain a base paper;
subjecting the base paper to impregnation in an impregnation solution, and then drying to obtain an impregnated paper, where the impregnation solution includes a phenolic resin and a nanocellulose; and
subjecting the impregnated paper to hot-pressing vulcanization at a temperature of less than or equal to 230° C. to obtain the highly wear-resistant wet paper-based friction material.

In some embodiments, the natural fiber comprises one or more selected from the group consisting of hemp fiber, cotton fiber, bamboo fiber, and wood pulp fiber;
the synthetic fiber comprises one or more selected from the group consisting of aramid fiber, carbon fiber, glass fiber, ceramic fiber, and polyimide fiber; and
a mass ratio of the natural fiber to the synthetic fiber is in a range of 1:0.1 to 1:8.

In some embodiments, the friction performance modifier comprises one or more selected from the group consisting of diatomaceous earth, silica, feldspar, barium sulfate, graphite, alumina, and an organic friction powder; and
a mass ratio of the natural fiber to the friction performance modifier is in a range of 1:0.1 to 1:12.

In some embodiments, the slurry has a solid content of 0.5% to 2.5%.

In some embodiments, the phenolic resin comprises one or more selected from the group consisting of an unmodified phenolic resin, cashew nut shell oil-modified phenolic resin, a melamine-modified phenolic resin, a latex-modified phenolic resin, and a boron-modified phenolic resin;
a dry weight of the nanocellulose accounts for 0.01% to 5% of a dry weight of the phenolic resin; and
the impregnation solution has a solid content of 20% to 50%.

In some embodiments, the impregnation is conducted for 3 min to 20 min.

In some embodiments, the hot-pressing vulcanization is conducted at a temperature of 150° C. to 230° C. under a pressure of 1 MPa to 30 MPa for 1 min to 30 min.

The present disclosure further provides a highly wear-resistant wet paper-based friction material prepared by the method as described in the above technical solutions.

In some embodiments, the highly wear-resistant wet paper-based friction material has a basis weight of 100 g/m² to 2,000 g/m² and a thickness of 0.2 mm to 5 mm.

The present disclosure further provides use of the highly wear-resistant wet paper-based friction material as described in the above technical solutions in a wet clutch or a wet brake device.

In the present disclosure, a natural fiber, a synthetic fiber, a friction performance modifier, and water are mixed to obtain a slurry, the slurry is subjected to dehydration forming, drying, impregnation, drying, and hot-pressing vulcanization at not greater than 230° C. in sequence to obtain the highly wear-resistant wet paper-based friction material. The preparation method according to the present discourse has simple process, convenient operation, a temperature in the whole preparation process not exceeding 230° C., low energy consumption, mild and easy-to-control reaction conditions, no need of special high-temperature resistant equipment, and low production cost. The preparation method according to the present discourse does not require highly flammable and toxic aluminum isopropoxide powder and flammable, toxic, and highly irritating tetraethylammonium hydroxide and di-n-propylamine chemical reagents, which shows high safety, environmental-friendly and easily-available raw materials, and no emission of organic toxic and harmful substances, and is suitable for industrial production.

Moreover, nanocellulose is a fiber aggregate with a diameter of less than 100 nm and a length of up to micrometer level obtained by treating a fiber through chemical, physical, biological methods or combinations thereof. The nanocellulose contains a large number of hydroxyl groups on its surface, and shows excellent mechanical properties, a large specific surface area, high crystallinity and transparency, low density, and desirable biodegradability and biocompatibility. Phenolic resin contains a large number of hydroxyl groups. The base paper is impregnated with an impregnation solution including phenolic resin, nanocellulose and ethanol. During the hot-pressing vulcanization, at least two chemical reactions occur. One is polycondensation between phenolic resin molecules, which polymerizes linear small-molecule phenolic resin into a network-shaped macromolecular phenolic resin, which is a main chemical reaction in the heating and curing of conventional highly wear-resistant wet paper-based friction material. The other is etherification of hydroxyl groups on the surface of nanocellulose with hydroxyl groups on the phenolic resin molecules, thus introducing nanocellulose into a polymer to form a phenolic resin-nanocellulose-phenolic resin macromolecule. The excellent mechanical properties of nanocellulose can improve the strength and flexibility of phenolic resin, thereby increasing wear resistance of the highly wear-resistant wet paper-based friction material and improving friction and wear properties of the materials. In addition, at the physical level, a large number of hydroxyl groups on the surface of nanocellulose and hydroxyl groups of phenolic resin macromolecules produce strong hydrogen bonding, which can further improve the strength and wear resistance of the materials.

### DETAILED DESCRIPTION OF THE EMBODIMENTS

The present disclosure provides a method for preparing a highly wear-resistant wet paper-based friction material, including the following steps:
mixing a natural fiber, a synthetic fiber, a friction performance modifier, and water to obtain a slurry;
subjecting the slurry to dehydration forming and drying in sequence to obtain a base paper;
subjecting the base paper to impregnation in an impregnation solution, and then drying to obtain an impregnated paper, where the impregnation solution includes a phenolic resin and a nanocellulose; and
subjecting the impregnated paper to hot-pressing vulcanization at a temperature of less than or equal to 230° C. to obtain the highly wear-resistant wet paper-based friction material.

In the present disclosure, unless otherwise specified, all materials and equipment used are commercially available items in the art.

In the present disclosure, a natural fiber, a synthetic fiber, a friction performance modifier, and water are mixed to obtain a slurry.

In the present disclosure, the natural fiber comprises preferably one or more selected from the group consisting of hemp fiber, cotton fiber, bamboo fiber, and wood pulp fiber, and more preferably the cotton fiber or a mixture of hemp fiber and cotton fiber; in some embodiments, a mass ratio of the hemp fiber to the cotton fiber in the mixture is in a range of 1:1. In the present disclosure, the natural fiber has a diameter of preferably 1 μm to 50 μm, more preferably 10 μm to 40 μm; and the natural fiber has a length of preferably 0.2 mm to 10 mm, more preferably 0.5 mm to 5 mm.

In some embodiments of the present disclosure, the synthetic fiber comprises one or more selected from the group consisting of aramid fiber, carbon fiber, glass fiber, ceramic fiber, and polyimide fiber. In the present disclosure, the synthetic fiber has a diameter of preferably 1 μm to 30 μm, more preferably 3 μm to 20 μm; and the synthetic fiber has a length of preferably 0.1 mm to 10 mm, more preferably 0.3 mm to 5 mm. In some embodiments of the present disclosure, the synthetic fiber includes a mixture of aramid fiber and carbon fiber, where a mass ratio of the aramid fiber to the carbon fiber in the mixture is in a range of preferably (8-13): (7-8), more preferably 1:1 or 13:7.

In the present disclosure, a mass ratio of the natural fiber to the synthetic fiber is in a range of preferably 1:0.1 to 1:8, more preferably 1:1 to 1:6, even more preferably 1:2 to 1:4, and specifically preferably 1:0.1, 1:0.5, 1:1, 1:1.5, 1:2, 1:2.5, 1:3, 1:3.5, 1:4, 1:4.5, 1:5, 1:5.5, 1:6, 1:6.5, 1:7, 1:7.5, or 1:8.

In some embodiments of the present disclosure, the friction performance modifier comprises one or more selected from the group consisting of diatomaceous earth, silica, feldspar, barium sulfate, graphite, alumina, and organic friction powder; in some embodiments, the feldspar comprises one or more selected from the group consisting of sodium feldspar, calcium feldspar, potassium feldspar, and barium feldspar; in some embodiments, the organic friction powder comprises one or more selected from the group consisting of rubber powder, cashew nut shell oil friction powder, tire powder, and amino ester powder. In some embodiments of the present discourse, in terms of mass fraction, the friction performance modifier is a first composite friction performance modifier or a second composite friction performance modifier; in some embodiments, the first composite friction performance modifier includes a mixture of diatomaceous earth, feldspar, graphite, rubber powder, and cashew nut shell oil friction powder at a mass ratio of 15:5:6:30:20; in some embodiments, the second composite friction performance modifier includes a mixture of diatomaceous earth, feldspar, alumina, graphite, and rubber powder at a mass ratio of 23:10:2:15:10. In the present disclosure, the friction performance modifier has a particle size of preferably 10 mesh to 800 mesh, more preferably 20 mesh to 350 mesh.

In the present disclosure, a mass ratio of the natural fiber to the friction performance modifier is in a range of preferably 1:0.1 to 1:12, more preferably 1:1 to 1:10, even more preferably 1:2 to 1:8, and specifically preferably 1:0.1, 1:0.5, 1:1, 1:1.5, 1:2, 1:2.5, 1:3, 1:3.5, 1:4, 1:4.5, 1:5, 1:5.5, 1:6, 1:6.5, 1:7, 1:7.5, 1:8, 1:8.5, 1:9, 1:9.5, 1:10, 1:10.5, 1:11, 1:11.5, or 1:12.

In the present disclosure, there is no special limitation on a mixing method, and any mixing method well known to those skilled in the art may be used, such as mixing by stirring.

In the present disclosure, the slurry has a solid content of preferably 0.5% to 2.5%, more preferably 1% to 2%, and even more preferably 1.5%.

In the present disclosure, the resulting slurry is subjected to dehydration forming and drying in sequence to obtain a base paper.

In some embodiments of the present disclosure, the dehydration forming includes: pouring the slurry into a former or a sheet maker, evenly dispersing the slurry, and conducting vacuum dehydration to obtain a first wet paper web; and subjecting the first wet paper web to pressing dehydration to obtain a second wet paper web.

In the present disclosure, the vacuum dehydration is conducted at a vacuum degree of preferably 0.01 MPa to 0.06 MPa, more preferably 0.02 MPa to 0.05 MPa, and even more preferably 0.03 MPa to 0.04 MPa. There is no special limitation on a time of the vacuum dehydration, as long as a solid content of the first wet paper web obtained by vacuum dehydration could be 10% to 25%. In some embodiments, the solid content is 15% to 20%, and the vacuum dehydration is specifically conducted for 3 seconds(s) to 300 s.

In some embodiments of the present disclosure, the pressing dehydration is conducted on a press. In the present disclosure, the second wet paper web has a moisture content of preferably 25% to 50%, more preferably 30% to 45%, and even more preferably 35% to 40%.

In the present disclosure, the drying is conducted at a temperature of preferably 70° C. to 110° C., more preferably 80° C. to 100° C., and even more preferably 90° C. to 95° C. for preferably 3 s to 600 s, more preferably 50 s to 500 s, and even more preferably 100 s to 300 s preferably in a drying cylinder, vacuum dryer, or oven.

In the present disclosure, the base paper is subjected to impregnation in an impregnation solution, and then dried to obtain an impregnated paper, wherein the impregnation solution includes a phenolic resin and a nanocellulose.

In the present disclosure, the phenolic resin comprises preferably one or more selected from the group consisting of unmodified phenolic resin (pure phenolic resin), cashew nut shell oil-modified phenolic resin, melamine-modified phenolic resin, latex-modified phenolic resin, and boron-modified phenolic resin. There is no special limitation on the phenolic resin, which may be commercial products well known to those skilled in the art or prepared by a preparation method well known to those skilled in the art. In one specific example, the phenolic resin is purchased from Shengquan Group, China.

In the present disclosure, the nanocellulose has a diameter of preferably less than 100 nm, and a length preferably in the micrometer range, more preferably 10 μm to 100 μm. In some embodiments, the nanocellulose is used in the form of nanocellulose dry powder or nanocellulose aqueous dispersion, and the nanocellulose aqueous dispersion has a solid content of preferably 1% to 6%, more preferably 2% to 5%, and even more preferably 3% to 4%. In the present disclosure, a dry weight of the nanocellulose preferably accounts for 0.01% to 5% of a dry weight of the phenolic resin, more preferably 0.1% to 4.5%, even more preferably 1% to 2%, and specifically preferably 0.01%, 0.05%, 0.1%, 1%, 1.5%, 2%, 2.5%, 3%, 3.5%, 4%, 4.5%, or 5%.

In the present disclosure, the nanocellulose is added into the impregnation solution, such that the nanocellulose reacts chemically with the phenolic resin to generate a network composite macromolecule during the hot-pressing vulcanization. The network composite macromolecule could improve the strength and toughness of the phenolic resin, thereby improving wear resistance of the highly wear-resistant wet paper-based friction material and improving the friction and wear performance of the highly wear-resistant wet paper-based friction material.

In the present disclosure, the impregnation solution has a solid content of preferably 20% to 50%, more preferably 25% to 45%, even more preferably 30% to 40%, and most preferably 35%. In some embodiments, a solvent in the impregnation solution is ethanol.

In some embodiments of the present disclosure, the impregnation solution is obtained by mixing a phenolic resin, a nanocellulose, and ethanol. In the present disclosure, the mixing is conducted at preferably room temperature for preferably 5 min to 90 min, more preferably 10 min to 60 min, and even more preferably 15 min to 45 min; the mixing preferably includes stirring mixing and/or ultrasonic mixing, more preferably the stirring mixing, or the ultrasonic mixing and the stirring mixing in sequence.

In the present disclosure, the impregnation is conducted at preferably room temperature for preferably 3 min to 20 min, more preferably 3 min to 20 min, and even more preferably 3 min to 20 min.

In the present disclosure, the impregnation has a glue content of preferably 20% to 40%, more preferably 30% to 35%, and specifically preferably 30.3%, 30.5%, 32.3%, or 32.4%; wherein the glue content=(mass of highly wear-resistant wet paper-based friction material−mass of base paper)/mass of highly wear-resistant wet paper-based friction material×100%.

In the present disclosure, the impregnated paper is subjected to hot-pressing vulcanization at not more than 230° C. to obtain the highly wear-resistant wet paper-based friction material.

In the present disclosure, the hot-pressing vulcanization is conducted at a temperature of preferably 150° C. to 230° C., more preferably 180° C. to 220° C., and even more preferably 200° C. to 210° C. under a pressure of preferably 1 MPa to 30 MPa, more preferably 1.5 MPa to 10 MPa, and even more preferably 2 MPa to 5 MPa for preferably 1 min to 30 min, more preferably 3 min to 20 min, and even more preferably 5 min to 10 min preferably in a vulcanizer.

The present disclosure provides a highly wear-resistant wet paper-based friction material prepared by the method as described in the above technical solutions.

In the present disclosure, the highly wear-resistant wet paper-based friction material has a basis weight of preferably 100 g/m² to 2,000 g/m², more preferably 200 g/m² to 1,500 g/m², even more preferably 300 g/m² to 1,000 g/m², and specifically preferably 342 g/m², 345 g/m², 407 g/m², or 408 g/m². The highly wear-resistant wet paper-based friction material has a thickness of preferably 0.2 mm to 5 mm, more preferably 0.25 mm to 2 mm, even more preferably 0.3 mm to 1 mm, most preferably 0.35 mm to 0.5 mm, and specifically preferably 0.379 mm, 0.392 mm, 0.398 mm, or 0.423 mm. The highly wear-resistant wet paper-based friction material has a dynamic friction coefficient of preferably not less than 0.093, more preferably 0.093 to 0.110, and specifically preferably 0.093, 0.104, 0.108, or 0.110. The highly wear-resistant wet paper-based friction material has a static friction coefficient of preferably not less than 0.124, more preferably 0.124 to 0.142, and specifically preferably 0.124, 0.133, or 0.142. The highly wear-resistant wet paper-based friction material has a wear rate preferably not more than 3×10⁻⁷ cm²/J, and specifically preferably 7×10⁻⁸ cm²/J, 1×10⁻⁷ cm²/J, or 3×10⁻⁷ cm²/J.

The present disclosure provides use of the highly wear-resistant wet paper-based friction material as described in the above technical solutions in a wet clutch or a wet brake device. In the present disclosure, the highly wear-resistant wet paper-based friction material is preferably used in a wet clutch or a wet brake device of various vehicles or engineering machinery, and more preferably in wet clutches in vehicle automatic transmissions, motorcycle clutches, and wet brakes on heavy vehicles. In some embodiments, the highly wear-resistant wet paper-based friction material works in an oil medium. In the present disclosure, the nanocellulose is added into the impregnation solution of phenolic resin, such that the nanocellulose reacts chemically with the phenolic resin to generate a network composite macromolecule during the hot-pressing vulcanization. The network composite macromolecule could improve the strength and toughness of the phenolic resin, thereby improving the wear resistance of the highly wear-resistant wet paper-based friction material and improving the friction and wear performance of the highly wear-resistant wet paper-based friction material, and has a desirable application prospect in wet clutches or wet brake devices of various vehicles or engineering machinery.

To further explain the present disclosure, the highly wear-resistant wet paper-based friction material, the preparation method and the use thereof provided in the present disclosure will be described in detail below in conjunction with examples which, however, should not be interpreted as limitations to the scope of the present disclosure.

In the following examples and comparative examples, the feldspar was potassium feldspar; the phenolic resin was a phenolic resin used in friction materials from Shengquan Group, China; the rubber powder was purchased from Cardolite; the nanocellulose has a diameter of less than 100 nm and a length of micrometer level.

### Comparative Example 1

In parts by mass, 8 parts of cotton fiber, 8 parts of aramid fiber, 8 parts of carbon fiber, 15 parts of diatomaceous earth, 5 parts of feldspar, 6 parts of graphite, 30 parts of rubber powder, and 20 parts of cashew nut shell oil friction powder were uniformly dispersed in water to obtain a slurry with a solid content of 1.5%. The slurry was poured into a former, uniformly dispersed, and vacuum dehydrated at a vacuum degree of 0.01 MPa to 0.06 MPa to a solid content of 10% to 25%, and then further dehydrated by a press to obtain a wet paper web with a moisture content of 40%. A resulting dehydrated wet paper web was dried in a vacuum dryer at 95° C. to obtain a base paper. The base paper was impregnated in a phenolic resin ethanol solution with a solid content of 30% at room temperature for 10 min, taken out, and dried at 105° C. for 10 min to obtain an impregnated paper with a glue content of 29.7%. The impregnated paper was subjected to hot-pressing vulcanization on a vulcanizer at 200° C. under 2 MPa for 5 min to obtain a highly wear-resistant wet paper-based friction material. The highly wear-resistant wet paper-based friction material has a basis weight of 408 g/m² and a thickness of 389 μm.

The friction and wear performance of the highly wear-resistant wet paper-based friction material was tested with an MM2000 friction performance tester. The highly wear-resistant wet paper-based friction material has a dynamic friction coefficient of 0.084 and a static friction coefficient of 0.095 at 2,000 r/min under 0.4 MPa. After 2,000 tests, the wear rate of the highly wear-resistant wet paper-based friction material is 5×10⁻⁷ cm²/J, meeting the requirements of Class 2 and Class 3 products in the Chinese national standard GB/T 37208-2018 “Nonmetallic paper based wet type frictional materials”.

### Comparative Example 2

In parts by mass, 10 parts of cotton fiber, 10 parts of hemp fiber, 13 parts of aramid fiber, 7 parts of carbon fiber, 23 parts of diatomaceous earth, 10 parts of feldspar, 2 parts of alumina, 15 parts of graphite, and 10 parts of rubber powder were uniformly dispersed in water to obtain a slurry with a solid content of 1.7%. The slurry was poured into a sheet maker, uniformly dispersed, and vacuum dehydrated at a vacuum degree of 0.01 MPa to 0.06 MPa to a solid content of 10% to 25%, and then further dehydrated by a press to obtain a wet paper web with a moisture content of 40%. A resulting dehydrated wet paper web was dried in a drying cylinder at 105° C. to obtain a base paper. The base paper was impregnated in a phenolic resin ethanol solution with a solid content of 34% at room temperature for 15 min, taken out, and dried at 100° C. for 30 min to obtain an impregnated paper with a glue content of 32.3%. The impregnated paper was subjected to hot-pressing vulcanization on a vulcanizer at 200° C. under 4 MPa for 3 min to obtain a highly wear-resistant wet paper-based friction material. The highly wear-resistant wet paper-based friction material has a basis weight of 338 g/m² and a thickness of 391 μm.

The friction and wear performance of the highly wear-resistant wet paper-based friction material was tested with an MM2000 friction performance tester. The highly wear-resistant wet paper-based friction material has a dynamic friction coefficient of 0.095 and a static friction coefficient of 0.106 at 2,000 r/min under 0.4 MPa. After 2,000 tests, the wear rate of the highly wear-resistant wet paper-based friction material is 2×10⁻⁷ cm²/J, meeting the requirements of Class 2 and Class 3 products in the Chinese national standard GB/T 37208-2018 “Nonmetallic paper based wet type frictional materials”.

### Example 1

In parts by mass, 8 parts of cotton fiber, 8 parts of aramid fiber, 8 parts of carbon fiber, 15 parts of diatomaceous earth, 5 parts of feldspar, 6 parts of graphite, 30 parts of rubber powder, and 20 parts of cashew nut shell oil friction powder were uniformly dispersed in water to obtain a slurry with a solid content of 1.5%. The slurry was poured into a sheet maker, uniformly dispersed, and vacuum dehydrated at a vacuum degree of 0.01 MPa to 0.06 MPa to a solid content of 10% to 25%, and then further dehydrated by a press to obtain a wet paper web with a moisture content of 40%. A resulting dehydrated wet paper web was dried in a vacuum dryer at 95° C. to obtain a base paper. A nanocellulose aqueous dispersion with a solid content of 4% was added into a phenolic resin ethanol solution with a solid content of 30%. A resulting mixture was mechanically stirred at room temperature for 15 min to obtain an impregnation solution. The base paper was impregnated in the impregnation solution at room temperature for 10 min, taken out, and dried at 105° C. for 10 min to obtain an impregnated paper with a glue content of 30.3%. The impregnated paper was subjected to hot-pressing vulcanization on a vulcanizer at 200° C. under 2 MPa for 5 min to obtain a highly wear-resistant wet paper-based friction material. The highly wear-resistant wet paper-based friction material has a basis weight of 407 g/m² and a thickness of 398 μm. Wherein, the dry weight of nanocellulose accounts for 0.5% of a dry weight of phenolic resin.

The friction and wear performance of the highly wear-resistant wet paper-based friction material was tested with an MM2000 friction performance tester. At 2,000 r/min under 0.4 MPa, the highly wear-resistant wet paper-based friction material has a dynamic friction coefficient of 0.093, which is 10.7% higher than that in Comparative Example 1, and a static friction coefficient of 0.124, which is 30.5% higher than that in Comparative Example 1. After 2,000 tests, the highly wear-resistant wet paper-based friction material has a wear rate of 3×10⁻⁷ cm²/J, which is 40% lower than that in Comparative Example 1. The results meet the requirements of Class 2 and Class 3 products in the Chinese national standard GB/T 37208-2018 “Nonmetallic paper based wet type frictional materials”.

### Example 2

In parts by mass, 8 parts of cotton fiber, 8 parts of aramid fiber, 8 parts of carbon fiber, 15 parts of diatomaceous earth, 5 parts of feldspar, 6 parts of graphite, 30 parts of rubber powder, and 20 parts of cashew nut shell oil friction powder were uniformly dispersed in water to obtain a slurry with a solid content of 1.7%. The slurry was poured into a sheet maker, uniformly dispersed, and vacuum dehydrated at a vacuum degree of 0.01 MPa to 0.06 MPa to a solid content of 10% to 25%, and then further dehydrated by a press to obtain a wet paper web with a moisture content of 40%. A resulting dehydrated wet paper web was dried in a vacuum dryer at 95° C. to obtain a base paper. A nanocellulose aqueous dispersion with a solid content of 4% was added into a phenolic resin ethanol solution with a solid content of 30%. A resulting mixture was mechanically stirred at room temperature for 30 min to obtain an impregnation solution. The base paper was impregnated in the impregnation solution at room temperature for 10 min, taken out, and dried at 105° C. for 10 min to obtain an impregnated paper with a glue content of 30.5%. The impregnated paper was subjected to hot-pressing vulcanization on a vulcanizer at 200° C. under 2 MPa for 5 min to obtain a highly wear-resistant wet paper-based friction material. The highly wear-resistant wet paper-based friction material has a basis weight of 408 g/m² and a thickness of 423 μm. Wherein, the dry weight of nanocellulose accounts for 1% of a dry weight of phenolic resin.

The friction and wear performance of the highly wear-resistant wet paper-based friction material was tested with an MM2000 friction performance tester. At 2,000 r/min under 0.4 MPa, the highly wear-resistant wet paper-based friction material has a dynamic friction coefficient of 0.104, which is 23.9% higher than that in Comparative Example 1, and a static friction coefficient of 0.133, which is 40% higher than that in Comparative Example 1. After 2,000 tests, the highly wear-resistant wet paper-based friction material has a wear rate of 1×10⁻⁷ cm²/J, which is 80% lower than that in Comparative Example 1. The results meet the requirements of Class 2 and Class 3 products in the Chinese national standard GB/T 37208-2018 “Nonmetallic paper based wet type frictional materials”.

### Example 3

In parts by mass, 10 parts of cotton fiber, 10 parts of hemp fiber, 13 parts of aramid fiber, 7 parts of carbon fiber, 23 parts of diatomaceous earth, 10 parts of feldspar, 2 parts of alumina, 15 parts of graphite, and 10 parts of rubber powder were uniformly dispersed in water to obtain a slurry with a solid content of 1.9%. The slurry was poured into a sheet maker, uniformly dispersed, and vacuum dehydrated at a vacuum degree of 0.01 MPa to 0.06 MPa to a solid content of 10% to 25%, and then further dehydrated by a press to obtain a wet paper web with a moisture content of 42%. A resulting dehydrated wet paper web was dried in a drying cylinder at 105° C. to obtain a base paper. A nanocellulose aqueous dispersion with a solid content of 4% was added into a phenolic resin ethanol solution with a solid content of 34%. A resulting mixture was mechanically stirred at room temperature for 30 min to obtain an impregnation solution. The base paper was impregnated in the impregnation solution at room temperature for 15 min, taken out, and dried at 100° C. for 30 min to obtain an impregnated paper with a glue content of 32.4%. The impregnated paper was subjected to hot-pressing vulcanization on a vulcanizer at 200° C. under 4 MPa for 3 min to obtain a highly wear-resistant wet paper-based friction material. The highly wear-resistant wet paper-based friction material has a basis weight of 342 g/m² and a thickness of 392 μm. Wherein, the dry weight of nanocellulose accounts for 0.05% of a dry weight of phenolic resin.

The friction and wear performance of the highly wear-resistant wet paper-based friction material was tested with an MM2000 friction performance tester. At 2,000 r/min under 0.4 MPa, the highly wear-resistant wet paper-based friction material has a dynamic friction coefficient of 0.108, which is 13.7% higher than that in Comparative Example 2, and a static friction coefficient of 0.133, which is 25.5% higher than that in Comparative Example 2. After 2,000 tests, the highly wear-resistant wet paper-based friction material has a wear rate of 1×10⁻⁷ cm²/J, which is 50% lower than that in Comparative Example 2. The results meet the requirements of Class 2 and Class 3 products in the Chinese national standard GB/T 37208-2018 “Nonmetallic paper based wet type frictional materials”.

### Example 4

In parts by mass, 10 parts of cotton fiber, 10 parts of hemp fiber, 13 parts of aramid fiber, 7 parts of carbon fiber, 23 parts of diatomaceous earth, 10 parts of feldspar, 2 parts of alumina, 15 parts of graphite, and 10 parts of rubber powder were uniformly dispersed in water to obtain a slurry with a solid content of 1.8%. The slurry was poured into a sheet maker, uniformly dispersed, and vacuum dehydrated at a vacuum degree of 0.01 MPa to 0.06 MPa to a solid content of 10% to 25%, and then further dehydrated by a press to obtain a wet paper web with a moisture content of 41%. A resulting dehydrated wet paper web was dried in a drying cylinder at 105° C. to obtain a base paper. A nanocellulose aqueous dispersion was added into a phenolic resin ethanol solution with a solid content of 34%. A resulting mixture was ultrasonically treated for 15 min and then mechanically stirred for 30 min to obtain an impregnation solution. The base paper was impregnated in the impregnation solution at room temperature for 15 min, taken out, and dried at 100° C. for 30 min to obtain an impregnated paper with a glue content of 32.3%. The impregnated paper was subjected to hot-pressing vulcanization on a vulcanizer at 200° C. under 4 MPa for 3 min to obtain a highly wear-resistant wet paper-based friction material. The highly wear-resistant wet paper-based friction material has a basis weight of 345 g/m² and a thickness of 379 μm. Wherein, the dry weight of nanocellulose accounted for 0.1% of a dry weight of phenolic resin.

The friction and wear performance of the highly wear-resistant wet paper-based friction material was tested with an MM2000 friction performance tester. At 2,000 r/min under 0.4 MPa, the highly wear-resistant wet paper-based friction material has a dynamic friction coefficient of 0.110, which was 15.8% higher than that in Comparative Example 2, and a static friction coefficient of 0.142, which was 34% higher than that in Comparative Example 2. After 2,000 tests, the highly wear-resistant wet paper-based friction material has a wear rate of 7×10⁻⁸ cm²/J, which is 65% lower than that in Comparative Example 2. The results meet the requirements of Class 2 and Class 3 products in the Chinese national standard GB/T 37208-2018 “Nonmetallic paper based wet type frictional materials”.

The above descriptions are merely preferred embodiments of the present disclosure. It should be noted that a person of ordinary skill in the art may further make several improvements and modifications without departing from the principle of the present disclosure, but such improvements and modifications should be deemed as falling within the scope of the present disclosure.

What is claimed is:

1. A method for preparing a wear-resistant wet paper-based friction material, comprising the following steps:
mixing a natural fiber, a synthetic fiber, a friction performance modifier, and water to obtain a slurry;
subjecting the slurry to dehydration forming and drying in sequence to obtain a base paper;
subjecting the base paper to impregnation in an impregnation solution, and then drying to obtain an impregnated paper, wherein the impregnation solution comprises a phenolic resin and a nanocellulose; and
subjecting the impregnated paper to hot-pressing vulcanization at a temperature of less than or equal to 230° C. to obtain the wear-resistant wet paper-based friction material.

2. The method according to claim 1, wherein the natural fiber comprises one or more selected from the group consisting of hemp fiber, cotton fiber, bamboo fiber, and wood pulp fiber;
the synthetic fiber comprises one or more selected from the group consisting of aramid fiber, carbon fiber, glass fiber, ceramic fiber, and polyimide fiber; and
a mass ratio of the natural fiber to the synthetic fiber is in a range of 1:0.1 to 1:8.

3. The method according to claim 1, wherein the friction performance modifier comprises one or more selected from the group consisting of diatomaceous earth, silica, feldspar, barium sulfate, graphite, alumina, and an organic friction powder; and
a mass ratio of the natural fiber to the friction performance modifier is in a range of 1:0.1 to 1:12.

4. The method according to claim 1, wherein the slurry has a solid content of 0.5% to 2.5%.

5. The method according to claim 2, wherein the slurry has a solid content of 0.5% to 2.5%.

6. The method according to claim 3, wherein the slurry has a solid content of 0.5% to 2.5%.

7. The method according to claim 1, wherein the phenolic resin comprises one or more selected from the group consisting of an unmodified phenolic resin, cashew nut shell oil-modified phenolic resin, a melamine-modified phenolic resin, a latex-modified phenolic resin, and a boron-modified phenolic resin;
a dry weight of the nanocellulose accounts for 0.01% to 5% of a dry weight of the phenolic resin; and
the impregnation solution has a solid content of 20% to 50%.

8. The method according to claim 1, wherein the impregnation is conducted for 3 min to 20 min.

9. The method according to claim 1, wherein the hot-pressing vulcanization is conducted at a temperature of 150° C. to 230° C. under a pressure of 1 MPa to 30 MPa for 1 min to 30 min.

10. A wear-resistant wet paper-based friction material prepared by the method according to claim 1.

11. The wear-resistant wet paper-based friction material according to claim 10, wherein the natural fiber comprises one or more selected from the group consisting of hemp fiber, cotton fiber, bamboo fiber, and wood pulp fiber;
the synthetic fiber comprises one or more selected from the group consisting of aramid fiber, carbon fiber, glass fiber, ceramic fiber, and polyimide fiber; and
a mass ratio of the natural fiber to the synthetic fiber is in a range of 1:0.1 to 1:8.

12. The wear-resistant wet paper-based friction material according to claim 10, wherein the friction performance modifier comprises one or more selected from the group consisting of diatomaceous earth, silica, feldspar, barium sulfate, graphite, alumina, and an organic friction powder; and
a mass ratio of the natural fiber to the friction performance modifier is in a range of 1:0.1 to 1:12.

13. The wear-resistant wet paper-based friction material according to claim 10, wherein the slurry has a solid content of 0.5% to 2.5%.

14. The wear-resistant wet paper-based friction material according to claim 10, wherein the phenolic resin comprises one or more selected from the group consisting of an unmodified phenolic resin, cashew nut shell oil-modified phenolic resin, a melamine-modified phenolic resin, a latex-modified phenolic resin, and a boron-modified phenolic resin;
a dry weight of the nanocellulose accounts for 0.01% to 5% of a dry weight of the phenolic resin; and
the impregnation solution has a solid content of 20% to 50%.

15. The wear-resistant wet paper-based friction material according to claim 10, wherein the wear-resistant wet paper-based friction material has a basis weight of 100 g/m² to 2,000 g/m² and a thickness of 0.2 mm to 5 mm.

16. A method of using the wear-resistant wet paper-based friction material according to claim 10, comprising using the wear-resistant wet paper-based friction material in a wet clutch or a wet brake device.

17. The method according to claim 16, wherein the wear-resistant wet paper-based friction material has a basis weight of 100 g/m² to 2,000 g/m² and a thickness of 0.2 mm to 5 mm.
